(19) United States
(12) Patent Application Publication
(10) Pub. No.: US 2018/0311625 A1
(43) Pub. Date: Nov. 1, 2018

(54) DYNAMIC MIXER FOR VISCOUS MATERIALS

(71) Applicant: DOW GLOBAL TECHNOLOGIES LLC, Midland, MI (US)

(72) Inventors: Pavan K. Valavala, Freeport, TX (US); Matthew J. Turpin, Sanford, MI (US); Mark A. Spalding, Midland, MI (US); Jeffery D. Zawisza, Midland, MI (US); Steve Allison, Midland, MI (US); Larry R. Ruddy, Lake Orion, MI (US); Nicholas E. Kennedy, Auburn Hills, MI (US); Charles Eslinger, Auburn Hills, MI (US); Laura J. Dietsche, Midland, MI (US)

(21) Appl. No.: 15/779,395

(22) PCT Filed: Mar. 1, 2016
(86) PCT No.: PCT/US2016/020204

§ 371 Date: May 25, 2018

Related U.S. Application Data
(60) Provisional application No. 62/262,607, filed on Dec. 3, 2015.

(51) Int. Cl. B01F 7/00; B01F 13/00; B01F 3/10; B01F 3/08

(52) U.S. Cl. CPC B01F 7/0065; B01F 13/0027; B01F 7/00391; B01F 7/0025; B01F 3/10; B01F 2215/0422; B01F 2215/006; B01F 2215/0495; B01F 2215/0481; B01F 2215/045; B01F 3/0853

(57) ABSTRACT

A dynamic mixer (40) comprising a rotatable structure (10, 111, 11, 1, 2, 3, 4, 5) having a cylindrical base (14) having a connector disposed at one end, an opposing thinned end, flights of 3 to 6 blades (11, 12, 151, 61), separated by a notches (13, 18) the blades (11, 12, 151, 61) have an inlet face facing the connector end, an outlet (30) face facing the thinned end, a leading edge (21) facing the direction of rotation, a trailing edge (20) opposite the leading edge (21), a standard leading face (154, 65) which tapers from the leading edge (21) to the outlet (30) face and a standard trailing face (166) which tapers from the trailing edge (20) to the inlet face, or a reverse leading face (154, 65) which tapers from the leading edge (21) to the inlet face and a reverse trailing face (155, 66) which tapers from the trailing edge (20) to the outlet (30) face, the notches (13, 18) are offset from one another and the article is adapted for use in a dynamic mixer (40) to mix viscous material when rotated in the mixer (40). An article comprising the mixer (40), a shell (25, 28, 29, 31) about the mixer (40) and an endplate (33) that defines material inlets and seals the inlet end (15, 27) of the mixer (40).

### FIELD

The disclosure relates to articles comprising a rotatable structure having a cylindrical structure and a plurality of flights of blades on a cylindrical structure. The disclosure further relates to a shell which contains the rotatable structure and which has an end plate to seal one end of the shell, wherein the disclosed structures are useful for applying multi-part, for instance two part, curable materials to substrates. The disclosure also relates to methods of applying multi-part curable materials to substrates using the structures disclosed.

### BACKGROUND

Two part curable compositions are used in a variety of applications such as adhesives, coatings, foams and the like, where rapid cure is required for the application, especially where the two parts are not shelf stable when in contact with one another. Shelf stable means that the composition does not cure in storage. Two part curable compositions which exhibit high viscosities may be difficult to mix and apply. Examples of such systems are disclosed in WO 2012/151086 and WO 2012/151085, incorporated herein by reference in their entirety. This is especially a problem where the two parts are mixed in a relatively high volumetric ratio of one part to the other. When the two parts are mixed in high volumetric ratio of one part to the other, the two dissimilar parts may be stored in a bag in bag tube, wherein the smaller volumetric part is stored in a bag disposed in the higher volumetric part. One of the bags is generally disposed along the outer wall forming the tube. The bag forms a barrier to contact of the two parts. This configuration allows for utilizing any volumetric ratio without concern for the size of the material tubes and their ability to work with standard two part dispensing apparatus. Common concerns include high back pressure of the curable material and thorough mixing of the materials. If the back pressure resulting from introducing highly viscous materials into the mixer used is too high, the curable materials will not pass through the mixing chamber and cannot be applied. If the two parts are not adequately mixed the curable material will not cure in a manner desired. A complicating factor is that many two part composition are applied in remote locations or by consumers, where there is limited or no access to applicators capable of applying sufficiently high pressures to overcome the back pressures and thoroughly mix the parts. Many common manually driven or battery driven applicators do not have the capability to overcome backpressures resulting from trying to pass a highly viscous material through mixers capable of properly mixing such compositions.

Complex mixing systems have been developed to address these problems, see EP 1,189,686; EP 1,830,070 and EP 2,011,562 incorporated herein by reference in their entirety. Such systems can be complicated to use or costly to manufacture. Commonly owned application, WO2014/142869 (US 2016/0008774) discloses a static mixer for viscous curable systems, incorporated herein by reference in its entirety. For very viscous systems dynamic mixers provide better mixing. Many mixing systems for very viscous systems are battery operated. Systems that minimize the power requirements to mix the materials are desired to extend the battery life and reduce the impact on the environment of disposing of or recycling used batteries.

What is needed is dynamic mixer systems that can thoroughly mix highly viscous two part compositions using manual and battery operated applicators without creating unacceptable back pressures, which are easy to use and can be manufactured in a cost effective manner. What are further needed are mixing systems that provide excellent mixing, with reasonable power consumption, and commercially acceptable flow rates of materials through the mixing systems. What are needed are methods for applying viscous two part curable systems utilizing such mixing systems.

### SUMMARY

Disclosed are structures useful as dynamic mixers, systems utilizing the dynamic mixers and methods of applying viscous curable materials to substrates. Disclosed is an article comprising: a rotatable structure having a cylindrical base having a connector to a rotating motor disposed at one end of the cylindrical base, a thinned (fluted) end which is disposed at the opposite end of the rotatable structure from the connector, wherein rotatable structure has a central axis passing through the center of the rotatable structure which is adapted to rotate around the central axis, from three to six flights of blades disposed on the cylindrical base wherein each flight of blades comprises from 2 to 6 blades which form a planar band, wherein the planar band is generally perpendicular to the central axis, wherein the blades of each flight are separated by a notch through which viscous material under pressure can flow and the blades have an inlet face substantially perpendicular to the central axis and facing connector end of the rotatable structure, an outlet face substantially perpendicular to the central axis and facing the thinned end of the rotatable structure, wherein the inlet face and the outlet face are substantially parallel to one another, a leading edge which is the edge of a blade facing the direction of rotation, a trailing edge which is the edge of the blade opposite the leading edge, wherein the blades may have a standard leading face which connects and tapers from the leading edge to the outlet face and a standard trailing face which connects and tapers from the trailing edge to the inlet face, or a reverse leading face which connects and tapers from the leading edge to the inlet face and a reverse trailing face which connects and tapers from the trailing edge to the outlet face; wherein at least two of the flights of blades have the standard leading faces and the standard trailing faces, and the notches in adjacent flights of blades are offset from one another in the direction of the central axis; disposed on the cylindrical base are a plurality of grooves that connect notches in adjacent flights of blades wherein the grooves are adapted to facilitate flow of the viscous material from one flight of blades to the next flight of blades; the article is adapted for use in a dynamic mixer to mix viscous material when rotated in the mixer. The grooves may extend from a notch in the first flight of blades through notches in each flight of blades. The grooves may form a helical structure in the cylindrical base as they connect the notches in each flight. One or two of the flights of blades may have reverse blades wherein the reverse leading face tapers from the leading edge to the inlet face and reverse trailing face tapers from the trailing edge to the outlet face. The reverse flights of blades may be disposed on the cylindrical base opposite the connector end of the rotating structure and toward the thinned end. The thinned end disposed away from cylindrical base may contain notches adapted to enhance mixing and flow of viscous material. The notches may be disposed transverse to the direction of the central axis.

Disclosed are articles comprising one or more of the rotatable structures disclosed herein, a shell which has an inlet end and an outlet end wherein the outlet end is smaller than the inlet end, wherein the rotatable structure is disposed in the shell, and an endplate disposed at the inlet end of the shell wherein the endplate comprises a structure to facilitate connection of the connector of the rotatable structure with the rotating motor, one or more inlets for viscous material to be mixed and functions to seal the inlet end of the shell. The shell may have a plurality of flights of blades disposed on the inner wall of the shell wherein the blades of each flight are separated by notches. The shell may have 1 to 8 flights of blades and the flights of blades may be disposed with respect to the flights of the blades of the rotatable structure in a manner such that a portion of the blades of the rotatable structure pass between the flights of blades of the shell.

Disclosed is a method comprising: a) introducing two or more parts of curable material having a high viscosity into the one or more inlets of the article comprising a rotatable structure, a shell and an endplate disclosed herein which is affixed to a dispensing apparatus having one or more motors for rotating the rotatable structure and for pushing the curable material through the article; b) applying sufficient pressure on the curable material to move the curable material through the shell in contact with the rotatable structure under conditions such that the two or more parts are mixed sufficiently to cure and perform the desired function of the curable material; and c) applying the mixed two parts of the curable material to one or more substrates. The method may further comprise the steps: d) contacting a first substrate with a second substrate with the mixed curable material disposed between the two substrates; and e) allowing the mixed curable material to cure and bond the two substrates together.

Systems utilizing the dynamic mixers disclosed are capable of mixing highly viscous materials. The mixers can be used with two or multiple part systems. Such systems can mix parts introduced from separate containers, tubes, or from the same container wherein the parts are kept separate from one another prior to mixing. The viscosity of the parts of the curable material may be up to about 2,500,000 centipoise. The system can mix the parts of curable material under conditions wherein a rotating motor is run at about 150 to about 700 RPM. The system can mix the parts when the flow rate of the curable material through the conical shell is about 400 g/min or greater. The power used to dispense two tubes, or a single divided tube, of curable material may be about 200 Watts or less.

The articles of the invention can be manufactured in multiple part (e. g.) two part) molds in a cost effective manner. The articles are effective in mixing two part curable compositions using manual or battery driven application systems.

### DESCRIPTION OF THE DRAWINGS

FIG. 1 shows samples of an adhesive 30 and 60 minutes after cure.

FIG. 2 shows a rotatable structure.

FIG. 3 shows the rotatable structure cut through the center along a plane represented by line A-A.

FIG. 4 is shows the rotatable structure from the outlet end of the structure looking toward the inlet end along a plane illustrated by line B-B.

FIG. 5 shows a shell in a cut through view.

FIG. 6 shows a cut through view of an end plate

FIG. 7 shows a rotatable structure seated in an endplate

FIG. 8 shows an exploded view of a mixer

FIG. 9 shows an assembled view of a mixer

FIG. 10 shows a cut through view of the mixer 40 along a plane shown by D-D of FIG. 9.

FIG. 11 shows a rotatable structure with reverse flights

FIG. 12 shows a shell with flights of blades on the inner wall

FIG. 13 shows a flight of blades in a cut through perspective based on the place defined by C-C of FIG. 3.

FIG. 14 shows a mixing system with a mixer

FIG. 15 shows the five rotatable structures according to the disclosure tested.

FIG. 16 shows an assembled mixer system with an alternative connector system to connect the endplate to the shell.

### DETAILED DESCRIPTION

The explanations and illustrations presented herein are intended to acquaint others skilled in the art with the invention, its principles, and its practical application. Accordingly, the specific embodiments of the present invention as set forth are not intended as being exhaustive or limiting of the invention. The scope of the invention should be determined with reference to the appended claims, along with the full scope of equivalents to which such claims are entitled. The disclosures of all articles and references, including patent applications and publications, are incorporated by reference for all purposes. The following claims are hereby incorporated by reference into this written description.

Disclosed is an article comprising a rotatable structure adapted to mix two or more parts of highly viscous curable material. Disclosed is a dynamic mixing system comprising the rotatable structure adapted for mixing one or more parts of a reactive composition, a shell adapted to be disposed about the rotatable structure which is adapted to contain the components to be mixed and the mixture formed and an endplate that seals the inlet end of the shell wherein the endplate has one or more inlets for the material to be mixed. The shell further comprises an outlet or nozzle for applying the mixture to a structure. The dynamic mixing system is useful for mixing highly viscous components with a motorized mixing applicator.

The rotatable structure comprises a cylindrical base and a thinned (fluted) end. The cylindrical base when in use is disposed toward the inlet of the shell. The thinned end of the rotatable structure is disposed toward the outlet end of the rotatable structure. The rotatable structure has a central axis passing through rotatable structure, including the cylindrical base and thinned end, about which it rotates. The central axis runs from the center of the inlet end of the shell through the center of the rotatable structure to the center of the outlet end of the shell. The flow of material through the shell is directed in the overall direction from the inlet to the outlet along the central axis. Material to be mixed and mixed material passes about the rotatable structure and through the shell in a direction along the central axis.

Disposed about the cylindrical base of the rotatable structure is a plurality of flights of blades. A flight of blades is a set of blades disposed in a planar band generally perpendicular to the central axis of the rotatable structure and perpendicular to the surface of the cylindrical base. The planar band is a band that bounds the blades in the flight at both the inlet faces and the outlet faces of the blades in the flight. Within the planar band the blades can be arranged in any manner with respect to the other blades in the flight. In some embodiments the inlet and outlet faces of the blades in a flight form planes perpendicular to the cylindrical base such that the blades are all at a common distance from the inlet and the outlet. The blades within a flight, planar band, may have the planes of their inlet and outlet faces, perpendicular to the central axis and the cylindrical base, located at different planes within the planar band. In this embodiment some of the blades in the planar band may be located at different distances from the inlet and outlet. The blades may be staggered with respect to each other such that alternating blades have inlet and outlet faces with common planes perpendicular to the central axis and the blades in the flight have two sets of common planes. One set is closer to the inlet and the other is closer to the outlet. Each blade in a flight may be further from the inlet and closer to the outlet from the next adjacent blade until returning to the first blade. One flight of blades can be distinguished from another flight because between each flight is an open space having no blades which is also open from the cylindrical base to the shell. The flight of blades comprise structures that protrude from the cylindrical base in a generally perpendicular direction from the cylindrical base. The blades either as a group or individually can protrude from the cylindrical base at an angle to a plane perpendicular to the central axis of up to 15 degrees either toward the inlet or the outlet, that is from greater than 0 degrees to about 15 degrees. Each protruding structure, or flight of blades, has a plurality of notches which divide the protruding structure into a plurality of blades. The blades function to split a stream of material to be mixed flowing through the shell into two streams. The notches, between and forming the blades, allow a portion of a split stream of the material to be mixed while flowing through the conical shell to the next flight of blades in the direction of the outlet of the conical shell. As the rotatable structure rotates the blades split the material flowing through the shell into multiple streams, some streams flow along the blades until such streams contact another blade and streams passing through the conical shell. Some streams split by each blade pass through the notches and flow toward the next flight of blades or the outlet and mix with streams flowing along the blades of the next flight. Generally each stream is split into a stream passing along the blade and one passing through a notch in the flight to the next flight. The material to be mixed as it flows through the shell is split into a plurality of streams and the formed streams are combined with other streams at different locations in the shell. As the material is split into streams and the split streams are combined a number of times as the material passes through the shell the goal of thorough mixing is achieved.

Each flight of blades contain a sufficient number of notches to form a sufficient number of blades to thoroughly mix the material as it passes through the shell from flight to flight and then out the outlet of the shell. If too few notches are present the material will not efficiently flow through the shell and unacceptable back pressure may result. If too many notches are present the material will flow through the shell without thorough mixing. The number of notches defines the number of blades in a flight. The number of notches may be three or greater or four or greater. The number of notches may be eight or less or six or less. The number of blades may be three or greater or four or greater. The number of blades may be eight or less or six or less.

The rotatable structure contains a plurality of flights of blades arranged in a plurality of planar bands perpendicular to the axis of the rotatable structure. The flights are arranged such that mixable material as it passes through the shell will contact blades of each flight to sequentially split the streams of material. The flights of blades are arranged sequentially along the cylindrical base of the rotatable structure from the inlet toward the outlet end, or from the connector to the thinned end. The number of flights of blades is chosen to thoroughly mix the mixable material in an efficient manner. Thoroughly mix means that parts of the mixable material are mixed so that the material can cure completely and cure at a consistent speed through the material. In addition is it desirable that the material to be mixed can be passed through the dynamic mixer disclosed herein with the consumption of the least amount of power possible. Thus it is desirable to minimize the back pressure created as the material moves through the dynamic mixer. The number of flights of blades may be two or greater, three or greater or four or greater. The number of flights of blades may be eight or less or six or less.

There are two types of blades and two types of flights of blades, standard and reverse. The difference between the two types of blades and flights of blades is the arrangement of the elements of the blades. The standard blades function to split the material and move the material generally toward the outlet. The reverse blades are designed to split the material and generally move a portion of the material toward the inlet so as to further enhance mixing. The blades in each flight all have an inlet face, an outlet face, a leading face, trailing face, a leading edge and a trailing edge. The inlet faces of the blades are substantially perpendicular to the central axis and faces the connector end of the rotatable structure and the inlet end of the shell and mixer. The outlet faces of each blade are substantially perpendicular to the central axis and faces the thinned end of the rotatable structure or the outlet end of the shell or mixer. The inlet face and outlet face of each blade are substantially parallel to one another. The leading edge is the edge of the blades adjacent to a notch, or formed by a notch, in the direction of rotation of the rotatable structure. The trailing edge of a blade is the edge adjacent to a notch, or formed by a notch, opposite to the direction of rotation. The leading edges for standard blades are formed by the intersection of the leading faces and the inlet faces of each blade. The trailing edges for standard blades are formed by the intersection of the trailing faces and the outlet faces. The leading edge of a standard blade is disposed toward the connector end of the rotatable structure and the inlet end of the mixer structure and the trailing edge is disposed toward the thinned end of the rotatable structure or the outlet end of the mixer structure. The leading faces for standard blades connect and taper from the leading edges to the outlet face. The trailing faces for standard blades connect and taper from the trailing edge to the inlet face. The leading faces for reverse blades connect and taper from the leading edges to the inlet faces. The trailing faces for reverse blades connect and taper from the trailing edge to the outlet faces. The leading edges of each blade are opposite from the trailing edges of each blade. The two edges are opposite in that the edges are on opposite ends of the blades from the perspective of the direction of rotation and opposite from one another in that the one connects to an inlet face and the other connects to an opposing outlet face. A flight of blades can be arranged to generally move the material toward the outlet and can be referred to a standard flights of blades and blades. The arrangement of the standard blade leading faces and trailing faces are arranged to push a portion of the material coming into contact with the standard blades toward the outlet. A flight of blades can be arranged to move a portion of the material toward the inlet to increase mixing, such flights of blades and blades can be referred to as reverse flights of blades or reverse blades. The arrangement of the reverse blade leading faces and trailing faces are arranged to push a portion of the material coming into contact with the reverse blades toward the inlet. The use of flights of reverse blade enhance mixing and increase back pressure. The faces, leading and trailing, may taper at any angle that enhances mixing of the components to be mixed. The taper may be at an angle with respect to the central axis of about 25 degrees or greater or about 45 degrees or greater. The taper be at an angle parallel to the plane of the flights of blades of about 65 degrees or less or about 55 degrees or less. Substantially perpendicular means the designated features form planes that are perpendicular or nearly perpendicular to the reference feature. Substantially perpendicular may mean that the angle of the plane of the designated feature with respect to the line or plane of the referenced feature is within 10 degrees of 90 degrees, within 5 degrees of 90 degrees or within 2 percent of 90 degrees. Substantially parallel means the two planes of the two compared features is within 10 degrees of one another, within 5 degrees of one another or within 2 degrees of one another.

At least two of the flights of blades may be reverse flights. All of the blades in a flight may be oriented in the same way with respect to the location of the leading edge and the direction of taper of the face. The rotatable structure may be rotated in a counterclockwise manner or a clockwise manner, from the perspective looking from the inlet end along the axis of rotation. The direction of rotation impacts which blade edge is leading and trailing. The reverse flights of blades can move the material to be mixed toward the inlet of the dynamic mixer based on the orientation of the leading edge and the leading face. This may result in the portion of the stream split by such blades which flows along the face of the blades to move through a notch in the flight of blades closer to the inlet. This enhances the mixing of the material. Alternatively the presence of reverse flights increases the back pressure in the system and requires more energy to pass the mixable material through the dynamic mixer. The number of reverse flights on a rotatable structure is chosen to balance enhanced mixing against increased energy consumption. One or two flights of blades may comprise reverse flights of blades. The reverse flights of blades may be disposed closest to the outlet. Thus where one or two reverse flights of blades are present the reverse flights of blades may be disposed on the rotatable structure so that they are the last or last two flights of blades before the outlet of the dynamic mixer. Locating the reverse flights of blades closest to the outlet results in less impact on back pressure than locating them closer to the inlet of the dynamic mixer. Locating the reverse flights of blades closest to the outlet of the dynamic mixer may enhance mixing of the mixable materials while minimizing the impact on back pressure in the system due to the use of reverse flights of blades. The material being mixed may undergo shear thinning, the viscosity is reduced, as a result of the shearing of the material as it is pushed through the mixer and it encounters the blades. This phenomena can result in less impact on power consumption where the reverse flights of blades are disposed closest to the outlet. The thickness of the blades may vary from flight to flight. The thickness of the blades may decrease from inlet to outlet. Thickness as used herein refers to the average thickness from the inlet face to the outlet face of the blades.

The size and number of notches in the flights of blades impact flow of mixable material and the efficiency of mixing. The number of notches is discussed in a previous section. The shape and size of the notches can impact both flow of material and mixing. Larger size notches reduce back pressure and the energy required to flow the mixable material through the dynamic mixer. Smaller size notches enhance the mixing and can increase back pressure. The shape and size of the notches are chosen to enhance flow of the mixable materials and the efficiency of mixing. The open area of the flight of blades impacts the efficiency of mixing. The open area is the area of the flight of blades occupied by the notches. This area is bounded by the outer edge of the flight of blades and the outer circumference of the cylindrical section of the rotatable structure. The open area is the area of the notches in this bounded area in a plane perpendicular to the direction of the central axis. The open area of the notches may be about 15 percent or greater, about 35 percent or greater, or about 38 percent or greater. The open area of the notches may be about 60 percent or less, about 48 percent or less about 45 percent or less. The notches in a flight of blades may have substantially the same area to enhance the mixing of the materials. As used in this context substantially the same area means that the area of all of the notches is within about 20 percent of the average or within about 15 percent. The shape of the notches in a plane perpendicular to the central axis, axis of rotation, may be any shape that provides the desired open area and enhances efficient mixing, for example a V shape with the point of the V disposed closest to the cylindrical base, U shaped with the base of the U disposed closest to the cylindrical base, a trapezoidal shape or non-linear or irregular in shape. The notches may be of the same or different shapes within a flight of blades. The notches may transition from one shape to another from flight to flight in an axial direction, in the direction of the axis of rotation or flow of material from the inlet to the outlet, which can minimize relatively low or no flow areas (dead spots). The notches in adjacent flights of blades may be offset from one another. The notches from flight to flight may not be lined up so that when the rotatable structure is not rotating and when looking in the direction of the axis of rotation from the inlet to the outlet the notches of the next later flight are not visible through the notches of an earlier flight. The offset notches enhance mixing by forcing different streams to combine due to the offset.

The cylindrical base of the rotatable structure may further comprise grooves that go from each of the notches in a flight of blades to notches in the next flight of blades. The grooves function to guide a portion of the stream passing through a notch to a notch on the next adjacent flight of blades. This structure enhances mixing of such stream with a stream flowing along the blades of the next adjacent flight of blades. Each notch in all of the flights of blades may be connected via a groove to another notch in an adjacent flight of blades. For the flights of blades disposed adjacent to two flights of blades each notch may be connected by grooves to two notches of adjacent flights of blades. The plurality of grooves connecting notches of adjacent flights may form a helical structure for portions of the mixable material to flow through the mixer. In this embodiment the flow of a portion of the material along the described structure may be described as flowing the material in a helical manner through the mixer. Due to the offset of the notches connected by grooves, the grooves exhibit an angle with respect to the plane of the blades. The angle used can impact mixing of the mixable material because the angle may impact the total distance traveled from entry to exit affecting the residence time of the materials inside mixing chamber. Further it may impact the angular direction of the flow with respect to the motion of the cylindrical base. The angle of the grooves as compared to the plane of the flights of blades may be about 15 degrees or greater. The angle of the grooves as compared to the plane of the flights of blades may be about 90 degrees or less, about 80 degrees or less, about 75 degrees or less.

The distance between the flights of blades impacts the flow of material through the mixer and the efficiency of the mixing. If the distance between the flights of blades is too low back pressure is created by the material flowing through the mixer. If the distance is too great mixing of the materials is compromised. The open area between the flights of the blades impacts the flow of material and the efficiency of the mixing. This area can be expressed as the product of the width of the open area and the depth of the open area. The depth is the average distance from the central portion of one flight of blades to the central portion of the next flight of blades. The width of the open area is the distance from the cylindrical base to the outer edge of the flight of blades. One way to express this relationship is as a ratio of the width and depth to the average thickness of the flight of the blades. The ratio of the average thickness of the blades to the depth of the open area may be about 1.0:0.5 or greater or 1.0:0.7 or greater. The ratio of the average thickness of the blades to the depth of the open area may be about 1.0:1.3 or less or about 1.0:1.1 or less. The ratio of the average thickness of the blades to the width of the open area may be about 1.0:0.5 or greater, or about 1.0:0.7 or greater. The ratio of the average thickness of the blades to the width of the open area may be about 1.0:1.5 or less or about 1.0:1.2 or less.

The flights of blades are disposed on the cylindrical base of the rotatable structure. The rotatable structure transitions from the cylindrical base to a thinned end. The thinned end is adapted to be placed away from the cylindrical base toward the outlet. The thinned end may taper from the cylindrical base toward the outlet to guide the material moving through the mixer toward the outlet and to reduce resistance to flow toward the outlet. The thinned end may have a fluted structure in that the thinned end is an elongated structure with a number of protruding ridges running from the cylindrical base toward the outlet. The ridges may form an angle in the direction of the outlet with reference to the central axis wherein the angle is chosen such that the ridges function to move the material passing through the mixer to the outlet. The number of ridges are selected to enhance flow of material toward the outlet and can be any number which facilitate this objective. The number of ridges may be 3 or greater. The number of ridges may be 6 or less. The number of ridges may be 4 such that this structure has cross-like cross-section wherein each arm of the cross-like structure is substantially the same length. The thinned end may have notches in the protruding ridges. The notches function to enhance mixing and the flow of viscous material toward the outlet. The one or more of the notches may be disposed at a different distance from the outlet such that they are offset from one another. The notches on opposing ridges may at the same distance from the outlet and on adjacent ridges located at a different distance from the outlet.

The length of the rotatable structure is selected to achieve thorough mixing with the minimum amount of power consumed to achieve the mixing. One practical limit on the length is that the dynamic mixer needs to be short enough such that the person applying the mixed viscous material can see the substrate and mixed viscous material applied to the substrate. The mixer should not block the view of a person applying the mixture of viscous material. The relationship of the diameter of the mixer at its largest diameter to the length of the mixer may be about 0.8:1.0 or greater. The ratio of the length of the mixer to its diameter is about 1.2:1.0 or less.

The dynamic mixer of this disclosure has a shell. The shell functions to contain the viscous material to be mixed in the mixer and to direct the viscous material to flow in contact with the flights of blades. The shell is fabricated from a material that can withstand the pressures generated by moving the viscous material through the dynamic mixer. The shell has walls that have a sufficient thickness taking into account the material of fabrication to withstand the pressures to which the walls will be exposed. One end of the shell is affixed to a handheld mixing gun. The end that viscous material is introduced into, the inlet end is affixed to the mixing gun. The shell has a mixing gun connector. The mixing gun connector can be any known connector that matches a connector on the handheld mixing gun that holds the dynamic mixer in place on the hand held mixing gun during operation of the mixing gun. The mixing gun connector needs to hold the dynamic mixer in place at the pressures generated during mixing. The mixing gun connector can be a set of threads that match threads on the mixing gun, snap fit connectors, twist lock, clamp, twist lock bayonet, and the like. The shell fits over and encloses the rotatable structure except for the one or more inlets and the outlet of the system. The distance between the rotatable structure and the shell is chosen so the viscous material can be directed to contact the flights of blades and such that the back pressure of the viscous material is not too great, that is the energy required to move the viscous material through the mixer is at an acceptable level. The shell may be substantially cylindrical in the portion of the shell that is adjacent to the cylindrical base of the rotatable structure so as to keep the clearance between the rotatable structure and the shell relatively constant. The distance from the edge of the flights of blades to the inner wall of the shell may be based on the distance from the edge of the blades to the cylindrical portion of the rotatable structure. This distance may be expressed as percentage of the distance from the outer edge of the blades to the cylindrical portion of the rotatable structure. This percentage may be about 1.5 percent of the specified distance or greater or about 5 percent or greater. The distance from the edge of the flights of blades to the inner wall of the shell may be about 20 percent of the specified distance or about 15 percent of the specified distance or less. The shell may have an outlet portion that tapers from the cylindrical portion to the outlet so as to direct the mixed viscous material toward the outlet. The outlet of the shell functions to facilitate application of the mixed viscous material to a substrate. The outlet can be of any shape or size which is suitable for applying the particular viscous material. Exemplary shapes of the outlet is a circular, ovular, rectangular, triangular or irregular shape and the like. The largest size of the outlet in any direction may be about 3 mm or greater, about 4 mm or greater or about 6 mm or greater. The largest size of the outlet in any direction may be about 20 mm or less, about 15 mm or less or about 10 mm or less. The inlet end of the shell is further adapted to receive an endplate which functions to seal the inlet end and to define one or more inlets for viscous material to be mixed.

The shell may further comprise flights of static blades on the inner wall adapted to enhance mixing of the viscous material. The flights of static blades protrude in from the inner wall of the shell. The flights of blades comprise notches that define the blades. Each flight of blades contains a sufficient number of notches to form a sufficient number of blades to thoroughly mix the material as it passes through the shell from flight to flight and then out the outlet of the conical shell. If too few notches are present the material will not efficiently flow through the shell and unacceptable back pressure may result. If too many notches are present the material will flow through the shell without thorough mixing. The number of notches define the number or blades in a flight and may be three or greater or four or greater. The number of notches may be eight or less or six or less. The number of blades may be 3 or greater or four or greater. The number of blades may be eight or less or six or less. The number of flights of blades on the inner surface of the shell may be one or greater, two or greater, three or greater or four or greater. The number of flights of blades may be eight or less, six or less, four or less or two or less.

The shell is adapted to fit over the rotatable structure and enclose it. When the shell is placed over the rotatable structure the flights of blades protruding from the inner wall of the shell may be disposed between the flights of blades of the rotatable structure in the direction of the central axis. The parts of the dynamic mixer need to be assembled in place on the handheld mixer. The width of the flights of blades on the inner wall of the shell may be selected such that the shell can be assembled over the rotatable structure, that is such flights of blades cannot interfere with assembly and the clearance between the flights of blades on the inner wall of the shell and the flights of blades of the rotatable structure must be sufficient to allow for assembly. The clearance should be chosen such that the mixing is enhanced without undue backpressure and attendant energy requirement penalties. During use of the dynamic mixer the rotatable structure rotates within the conical shell. The flights of blades on the inner wall of the conical shell cannot impede the rotation of the rotatable structure.

The dynamic mixer disclosed further comprises an endplate which is disposed on the inlet end of the shell. The endplate seals the inlet end of the shell to prevent leakage of the viscous materials to be mixed from the inlet end of the mixer. Any seal that prevents leakage may be utilized, for example an o ring, a polymer seal groove, lip seal, and the like.

The endplate further provides a sealed passage through which the connector to the rotatable motor of the rotatable structure can pass so that the connector may engage the rotatable motor of a mixing apparatus. The rotatable structure may be connected to the rotatable motor using an extension that connects the rotatable structure and the motor and which passes through the endplate. The endplate further comprises one or more inlets for material to be mixed. The number of inlets is based on the number of containers from which the materials to be mixed are introduced. The materials to be mixed may be introduced from a single container wherein the parts to be mixed are separated from one another. The material to be mixed may be introduced from two or more containers and an inlet is provided for each container. The material to be mixed may be introduced from two containers and thus there are two inlets. There may be one inlet. There may be two or more inlets. The inlet may be located near or adjacent to the first flight of blades with respect to the inlet. The flight of blades can be located close enough to the inlet such that the blades of the flight prevent material from entering the shell and that when the notches between the blades are adjacent to the inlet material is allowed to enter the shell. In this embodiment the material to be mixed is only allowed to enter the shell when a notch is over the inlet and the material is alternatively held out of the shell and allowed in the shell based on whether blades or notches are adjacent to the inlet.

The mixer disclosed may further comprise a tip disposed over the outlet to further shape the mixed material passed out of the mixer. The tip may be shaped to provide a desired shape of the material dispensed such as a bead. The tip may have any of the cross-sectional shapes disclosed as useful for the outlet.

The parts of the mixer are prepared from any material that can be molded in a multi part (i.e. two part) molding system or which can be formed by casting. Exemplary materials include thermoplastics, thermosets, metals and the like. Preferred materials are thermoplastics and thermosets, with thermoplastics preferred. Preferred thermoplastics comprise any plastic with a glass transition temperature or heat deflection temperature above room temperature and include polyolefins, polyamides, polystyrenes, acrylonitrile butadiene styrene (ABS), blends of acrylonitrile butadiene styrene with polycarbonate (PC/ABS) and the like. Preferred thermosets comprise any thermosetting material with a heat deflection temperature above room temperature and include polyurethanes, polyureas, acrylics, polyesters, epoxies and the like. The materials may further comprise fillers, reinforcing agents, internal mold release agents, stabilizers, antioxidants, fire retardants and the like known to those skilled in the art. Exemplary fillers include talc, fumed silica and the like. Preferred reinforcing fibers include polymer, glass, carbon fibers, ceramics, clays and the like.

The structures disclosed herein are prepared by molding. Preferably injection molding. Preferably the mold is a two part mold having actuated slides. In essence, the moldable material is converted into a flowable material. This may be achieved by heating the material to a temperature at which it is molten. The moldable material is injected into a closed mold as described. The mold may be treated with a mold release prior to injection of the moldable material or the moldable material may contain an internal mold release. After injection the moldable material is cooled or allowed to cool and the mold is opened to release the parts. The particular conditions for molding are material dependent and on a variety of parameters. One skilled in the art can determine the appropriate conditions for the specific moldable material. After removal from the mold any flashing is removed.

The mixer disclosed can be used for a variety of purposes, for example as mixers, blenders, applicators, rheology modifiers and the like. The articles may be used as dynamic mixers for mixing viscous materials. The mixers may be used for multipart systems that are reactive and mixed just prior to use, for example adhesives, coatings, body fillers, foamed plastics or polymers, dispersions and the like. The articles may be used for two part systems. The articles may be used for adhesive systems. Mixing systems that the mixers can be utilized with typically comprise one or two motors. One motor is a motor adapted to advance the materials to be mixed through the mixer of the invention. That same motor may also be utilized to rotate the rotatable structure so as to mix the parts to be mixed in the shell. The mixer may comprise two separate motors, one for pushing the materials to be mixed through the shell and one for rotating the rotatable structure to mix the parts. The end plate on the shell generally contains one or more passages for introduction of the material to be mixed into the conical shell. Commonly the parts to be mixed are disposed in two or more, preferably two, separate tubes of the material to be mixed. Typically the material in each tube is reactive with the material in the other tube and the components start to cure when mixed. Alternatively the two or more parts, preferably two parts, may be located in the same tube with a membrane or film separating the parts so that they are not in contact in the tube. The smaller volume part is typically located in an inner bag. Often the part in the inner bag is located along the side of the tube. Thus the mixer needs to disperse the smaller part throughout the mixed materials to achieve even cure of the materials. This system is often referred to as a bag-in-bag system and is often utilized when the volumetric ratio of the two parts is high. The ratio of materials to be mixed may be about 15:1 or less or about 10:1 or less. The ratio of materials to be mixed may be greater than 1:1, 2:1 or greater, or 3:1 or greater. This type of system allows the use of materials having odd volumetric ratios. The outlet, nozzle, of the shell may be shaped to extrude a bead of the mixed material of a desired shape. In mixing the pressure applied to the materials being mixed is sufficient to overcome the back pressure of the materials being mixed as it passes through the shell. This system is especially useful with battery operated mixing systems as such systems are limited in the amount of pressure that can be applied to the materials. Such systems are typically utilized outside of workshops, for instance by wind shield installers working remotely. The mixers utilized may apply pressure to the materials moved through the mixer of about 100 psi (689 kPa) or greater, about 150 psi (1034 kPa)) or greater and most preferably about 200 psi (1379 kPa) or greater. The mixers utilized may apply pressure to the materials moved through the mixer of about 500 psi (3447 kPa) or less or about 300 psi (2068 kPa) or less.

Adequate mixing means that the parts mix sufficiently to cure evenly throughout the applied mixture. Undue back pressure means that the material cannot be moved through the mixing tubes with the available system for applying pressure to the mixed materials, for example a battery operated mixing system. The inlet end is the end to which the materials to be mixed are introduced.

The mixers disclosed are useful in mixing any multipart compositions, preferably two part compositions. Such mixers are useful in mixing highly viscous multipart systems. The mixers disclosed may be useful in mixing systems having a viscosity of about 100,000 centipoise or greater or about 250,000 centipoise or greater. The mixers disclosed may be useful in mixing systems having a viscosity of about 5,000,000 centipoise or less, about 4, 000, 000 or less, about 2,500,000 centipoise or less or about 2,000,000 centipoise or less. The mixers can be used to mix any curable systems, for example adhesive systems. The mixers can be utilized to mix two part hybrid systems containing isocyanate functional prepolymers and acrylate containing monomers, oligomers or polymers, such systems are disclosed in WO 2012/151086 and WO 2012/151085, incorporated herein by reference.

In use the mixers of the invention are assembled on the handheld mixing system. The end plate is placed about the connector of the mixing system, the connector of the rotatable structure is connected to the connector of the mixing system and the shell is placed over the rotatable structure and engaged with the endplate to seal the shell about the rotatable structure. Where used a tip is placed over the outlet.

The separate parts are placed into the mixing system and passed into and through the dynamic mixer to mix the parts. As the mixed parts are passed through the outlet such mixed parts are applied to a substrate. Where the mixed parts are useful as an adhesive two substrates are contacted with the mixed parts disposed between them and the mixed parts are allowed to cure and bond the substrates together.

The functional attributes of the dynamic mixer disclosed include thorough mixing as defined herein with the use of the minimum power consumption necessary to achieve the thorough mixing. Thorough mixing and power consumption are impacted by the revolutions per minute (RPM) of the rotatable structure during the mixing process. If the RPM of the rotatable structure is too low the viscous materials will not be thoroughly mixed. If the RPM are too high the poor mixing will occur and power consumption will be too high. The RPM may be about 140 or greater or about 200 RPM or greater. The RPM may be about 700 or less, about 650 or less, 350 or less or about 300 RPM or less. In those embodiments wherein one or two of the flights of blades on the rotatable structure are reverse flights, the RPM desirable is impacted. In some of these embodiments the RPM may be about 100 or greater or about 200 RPM or greater. In some of these embodiments the RPM may be about 400 or less or about 300 RPM or less.

The mixing systems used with the dynamic mixer disclosed also provide a motor that pushes the viscous material through the mixer. It is desirable to minimize the power consumption used for this function. The power consumption can be expressed as the power used to apply one or more tubes of material to be mixed in watts. The power consumed is a can be measured in watts. The objective is to thoroughly mix the viscous materials while minimizing the total power used. The power used may be 200 watts or less, about 190 or less or about 170 or less.

The viscous materials need to be passed through the mixer in at a reasonable flow rate so that the materials can be applied before curing and to provide a reasonable open time to allow necessary manipulation of the substrates. The flow rate is selected to achieve this objective. The flow rate may be about 150 g per minute or greater, 200 g per minute or greater or about 400 g per minute or greater. The flow rate may be 700 grams per minutes or less. The open time may be 8 minutes or greater or 15 minutes or greater. The open time may be 30 minutes or less.

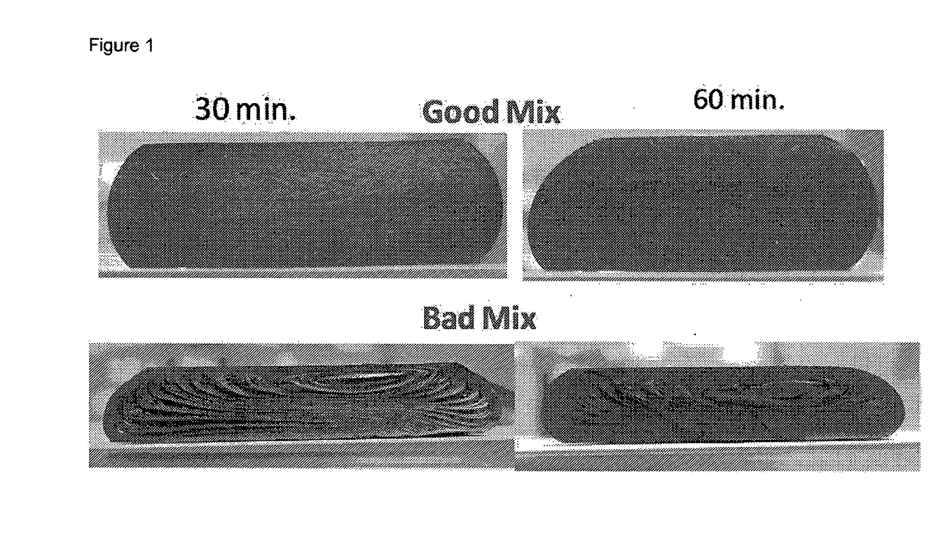

A qualitative measure of the thoroughness of mixing is described using mix percent. This is a qualitative assessment of the visual quality or presence of striations through the cross section of the material after passing through a mixer. FIG. 1 provides an illustration of good and poor mixing. The visual inspection is translated to a number ranking system on a scale of 100 with 100 representing best mix. The mix percentage may be about 80 or greater, about 85 or greater or about 90 or greater.

In the context of the use of the mixers disclosed herein for a two part hybrid systems containing isocyanate functional prepolymers and acrylate containing monomers, oligomers or polymers, as disclosed in WO 2012/151086 and WO 2012/151085, incorporated herein by reference, the quality of mixing can be indicated by the Shore A hardness of a mixture at 30 or 60 minutes after application to a substrate, that is after dispensing from the outlet of a mixer. The Shore A hardness may be about 15 or greater after 30 minutes or about 19 or greater after 30 minutes. The Shore A hardness may be about 40 or greater after 60 minutes. It is believed that improved mixing results in a higher Shore A hardness up until completely thorough mixing is achieved. The Shore A hardness is determined using the following procedure. A test specimen that is at least 6 mm thick and has 12 mm in the lateral direction from each edge is used. The durometer is held in a vertical position with a point of indentation at least 12 mm from an edge. The pressure foot is applied to the specimen as rapidly as possible, without shock, while keeping the foot parallel to the surface of the specimen. Sufficient pressure is applied to obtain firm contact between the presser foot and specimen. 5 measurements of hardness at different positions on the specimen at least 6 mm apart and the mean is determined.

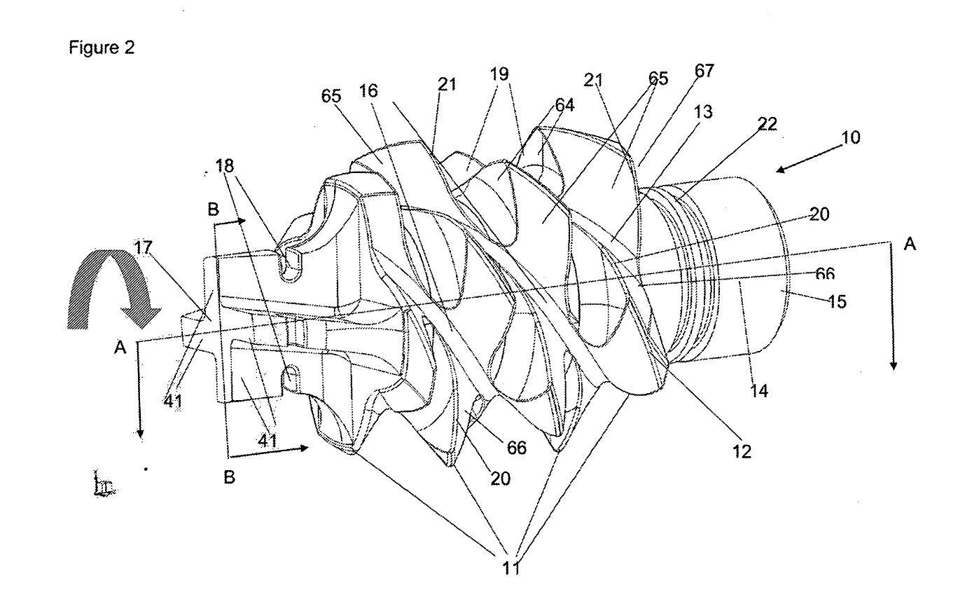

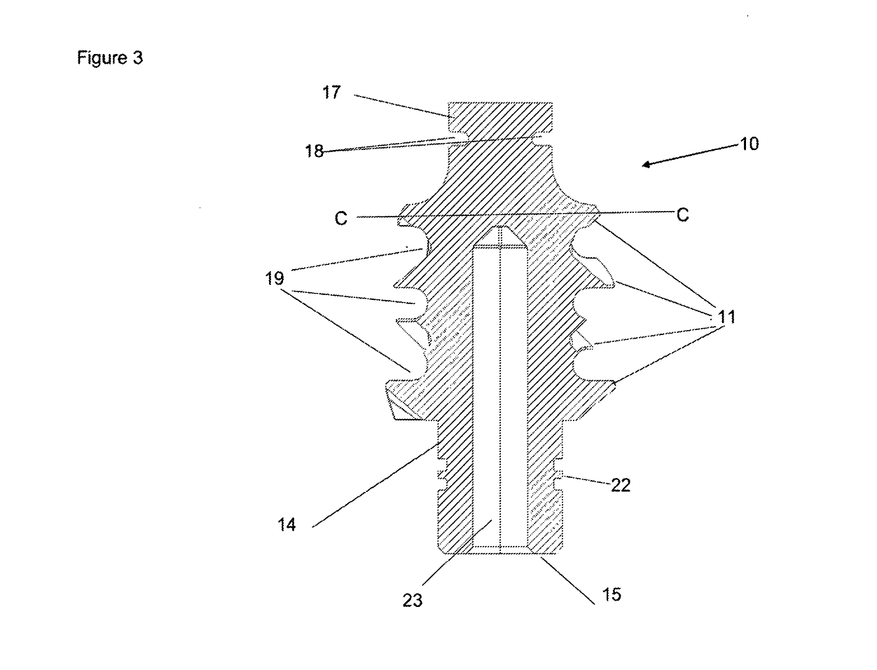

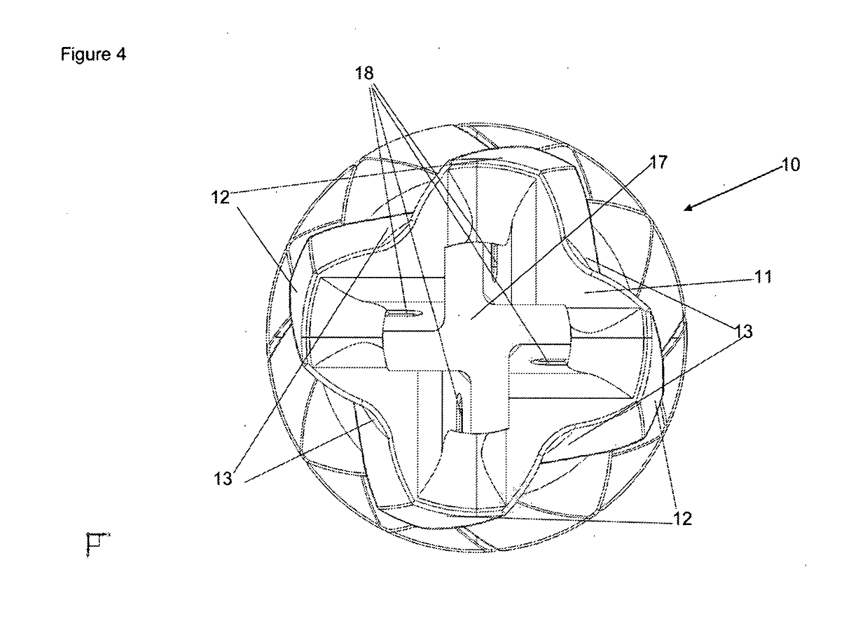

FIG. 1 shows samples of an adhesive 30 and 60 minutes after cure wherein the mix is good and bad or unacceptable. FIG. 2 shows a rotatable structure 10. FIG. 3 shows the rotatable structure cut through the center along a plane represented by line A-A. FIG. 4 shows the rotatable structure from the outlet end of the structure looking toward the inlet end along a plane illustrated by line B-B. The rotatable structure comprises a number of flights of blades 11 comprising individual blades 12. Between the blades 12 are notches 13. The rotatable structure 10 has a cylindrical base 14 and an inlet end 15. Shown are grooves 16 that traverse the cylindrical base 14. The flights of blades 11 protrude from the cylindrical base 14. The rotatable structure 10 has a tapered end (thinned end) 17 with ridges 41 with notches 18 in the ridges 41. Also shown are the spaces 19 between the flights of blades 11. The trailing edge 20 and the leading edge 21 of the blades are shown. The inlet face of a blade 67 and the outlet face of a blade 64 is shown. The leading face 65 and the trailing face 66 of a standard blade is shown. In FIGS. 2 and 3 a double O ring seal 22 is shown. Also shown is the hollow center 23 of the rotatable structure.

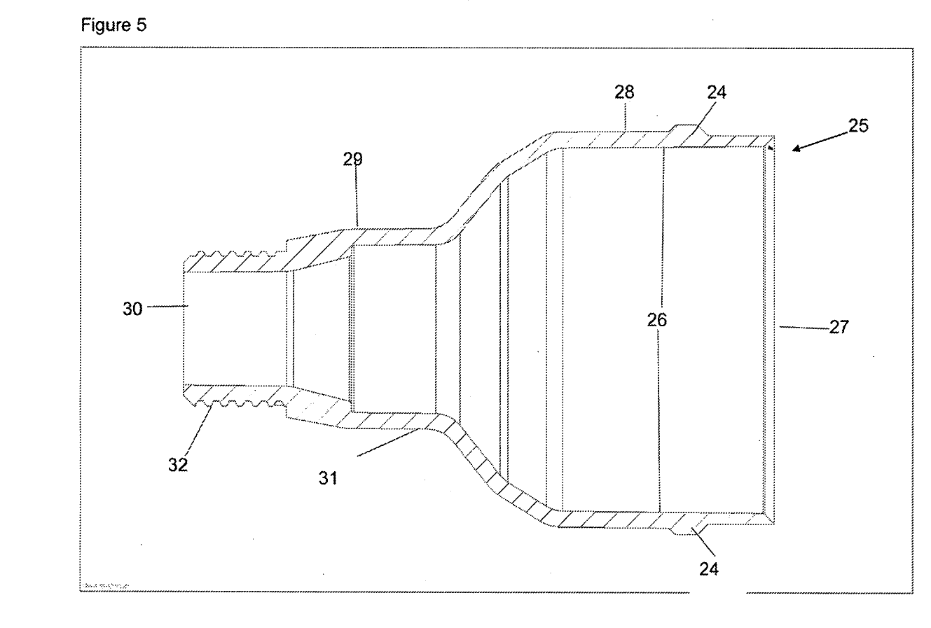

FIG. 5 shows a shell 25 in a cut through view. Shown are the inlet end 27, the outlet end 30, the inner wall 26, the outer wall of the shell 29, the cylindrical portion of the shell 28, the outlet portion of the shell 31, and threads 32 on the exterior portion of the outlet portion of the shell 31 of the shell 25. Also shown is a twist lock thread 24 for connecting and securing the shell 25 to the end plate 33.

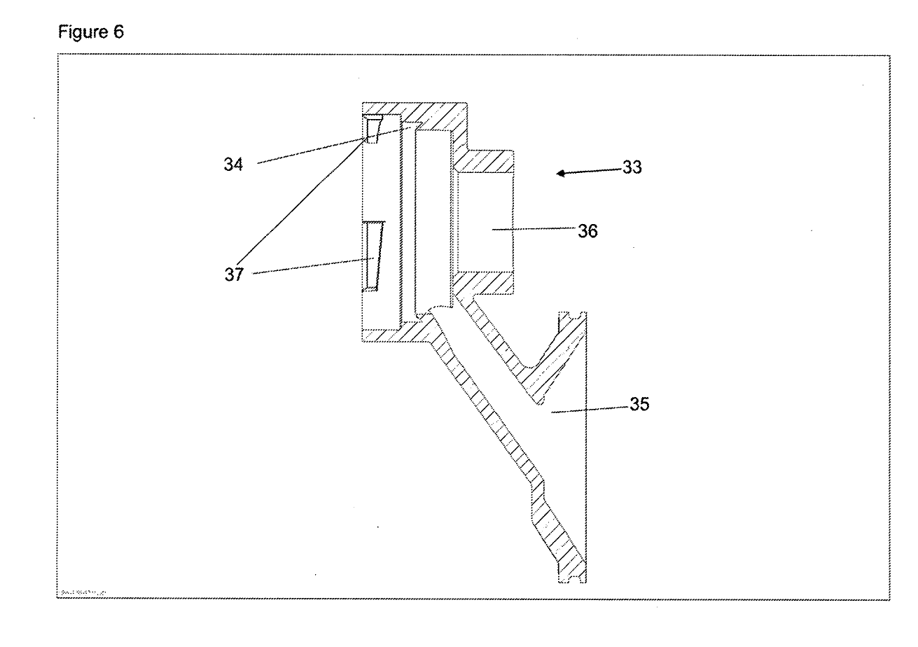

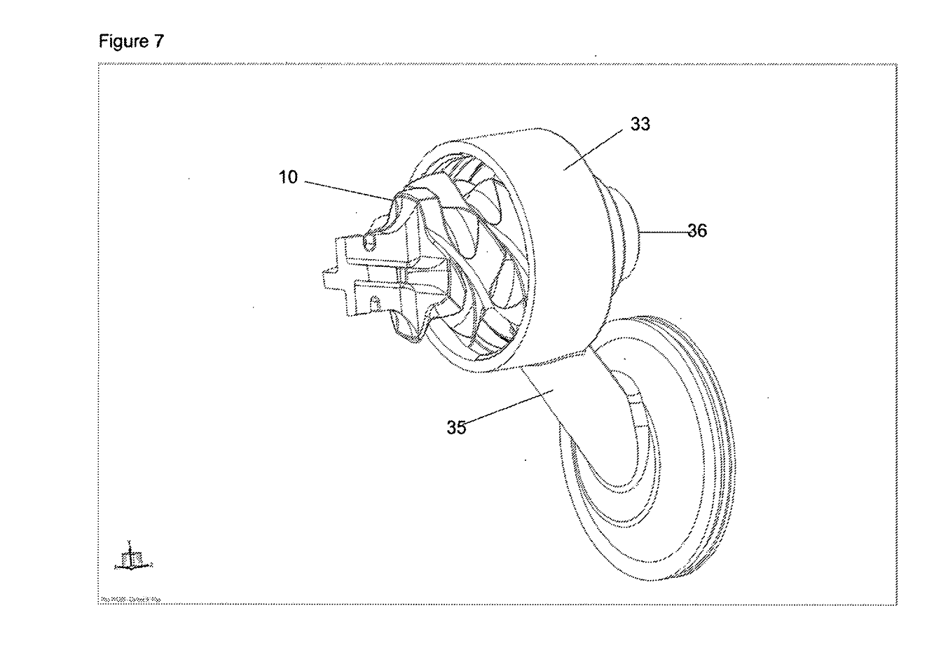

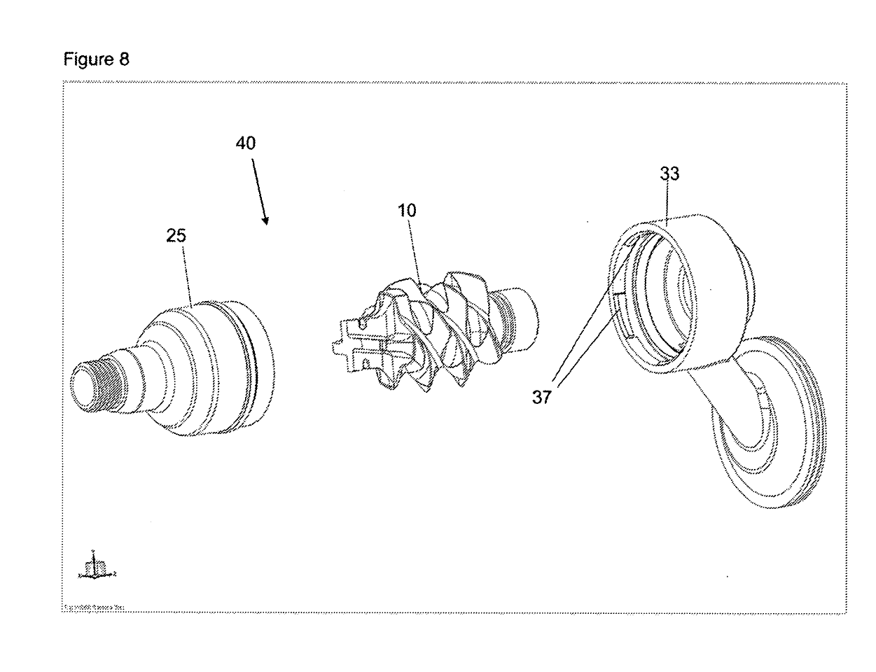

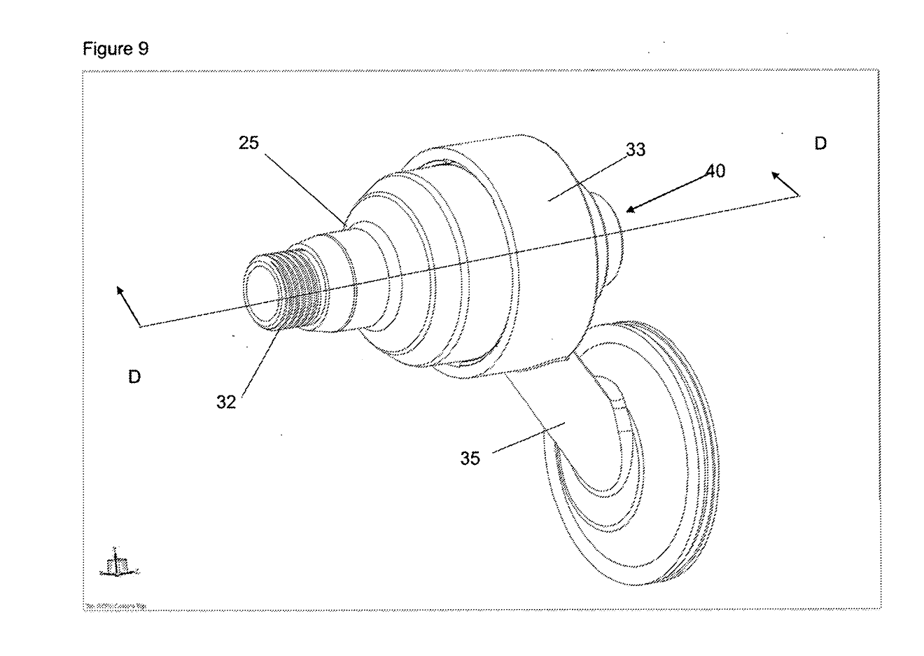

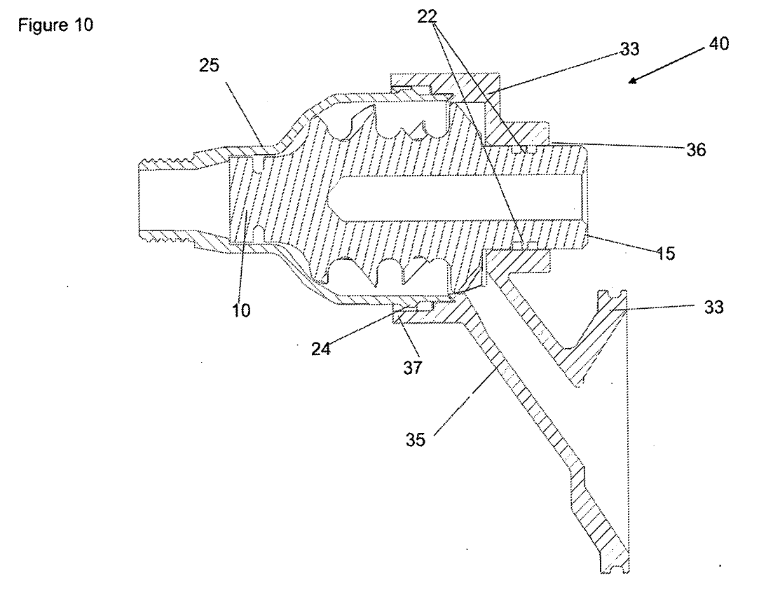

FIG. 6 shows a cut through view of an end plate 33 having a sealing section 34, a material inlet 35, and a passage 36 for a connection to the rotating drive of a dispensing system motor not shown. An endplate twist lock thread 37 is shown which is adapted to mate with the twist lock thread 42 on the shell 25 to hold the end plate 33 and shell 25 together. FIG. 7 shows the rotatable structure 11 seated in the endplate 33. FIG. 8 shows an exploded view of a mixer 40 disclosed herein comprising a rotatable structure 10, a shell 25 and an end plate 33 having twist lock threads 37. FIG. 9 shows an assembled view of a mixer 40 disclosed herein including the shell 25 with threads 32 for a dispense nozzle and an end plate 33 with a feed inlet 35. FIG. 10 shows a cut through view of the mixer 40 along a plane shown by D-D. FIG. 10 also shows the twist lock thread 24 of the shell 25 engaged with the twist lock thread 37 of the endplate 33 to hold the two parts together.

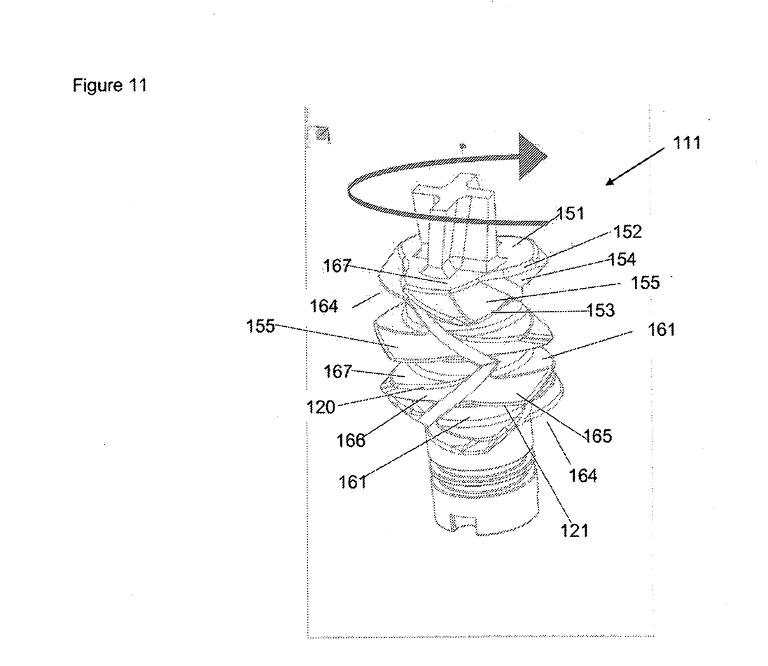

FIG. 11 shows a rotatable structure 111 having reverse flights of blades 151. Shown are the reverse flight leading edge 152 and the reverse flight trailing edge 153. Also shown are two standard flights (not reverse) 161 with blade leading edges 121 and blade trailing edges 120 for the standard flights. Shown is the leading face 154 and the trailing face 155 of a reverse blade. Also shown are inlet faces 164 and outlet faces 167 of the blades. Also shown are the standard blade leading face 165 and the standard trailing face 166. Rotation for this rotatable structure is counterclockwise from the perspective looking from the inlet end along the axis of rotation as shown by the arrow.

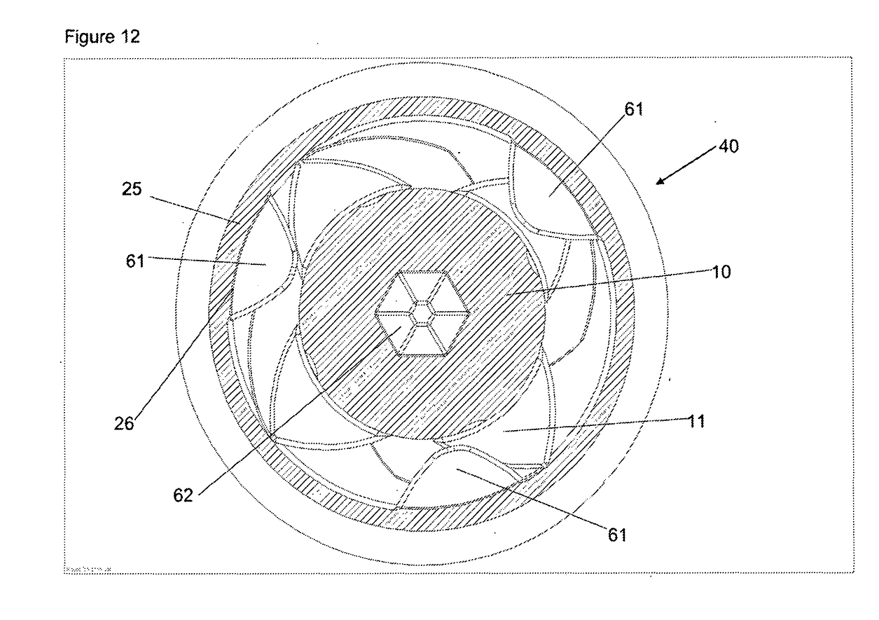

FIG. 12 shows a mixer 40 having a shell 25 with flights of blades 61 protruding from the shell inner wall 26. Also shown is the offset of flights of blades 61 on the shell 25 from the flights of blades 11 of the rotatable structure 10. The drawing shows the connector to the rotating motor 62.

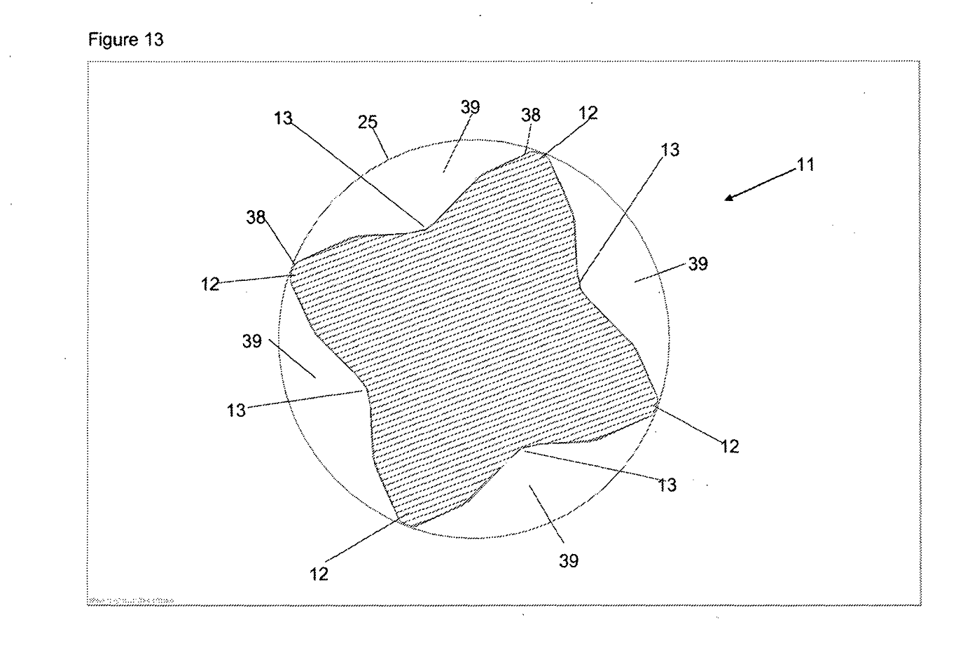

FIG. 13 shows a cut through view of a flight of blades 11 along the plane defined by C-C of FIG. 3. Shown are four blades 12 and four notches 13 defining the blades 12. Also shown is the shell 25 disposed about the flight of blades. The open area 39 formed by the notches 13 is shown as the area bounded by two blades 12 a notch 13 and the shell 25. The open area 39 starts at the tip 38 of one side of a blade 12 and goes to the tip 38 of the side of the other blade 12 formed by a notch 13.

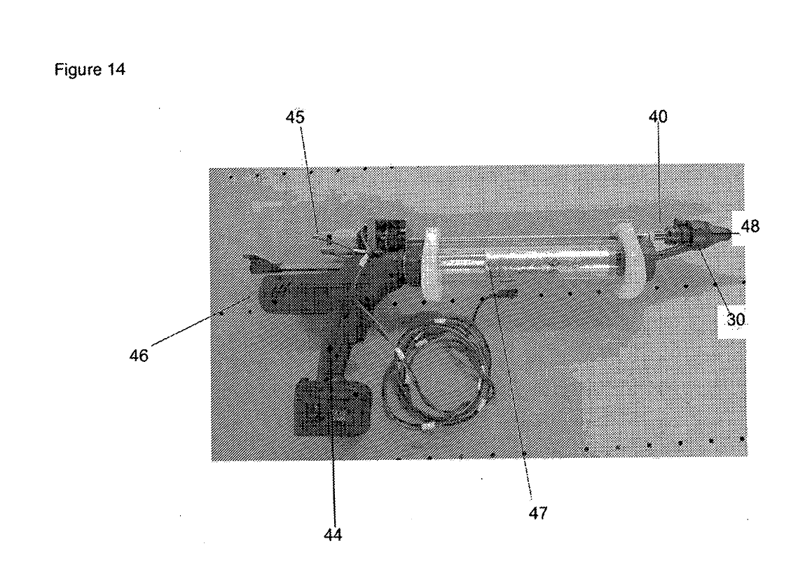

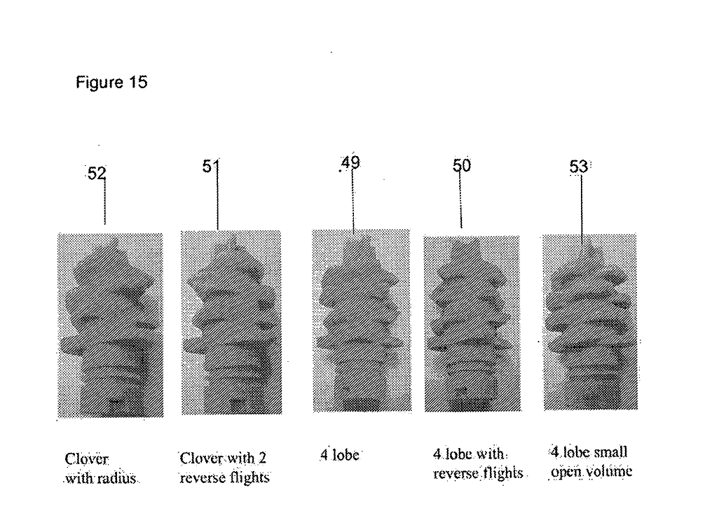

FIG. 14 shows a mixing system 44 with the mixer disclosed 40 mounted to it. The rotational motor 45 and push motor 46 of the mixing system 44 are shown. A tube of adhesive 47 is mounted in the mixing system 44. A dispense nozzle 48 is attached at the end of the outlet 30 of the dynamic mixer 40. FIG. 15 shows the five rotatable structures according to the disclosure tested. Rotatable structure 1 is 49, rotatable structure 2 is 50, rotatable structure 3 is 51, rotatable structure 4 is 52 and rotatable structure 5 is 53.

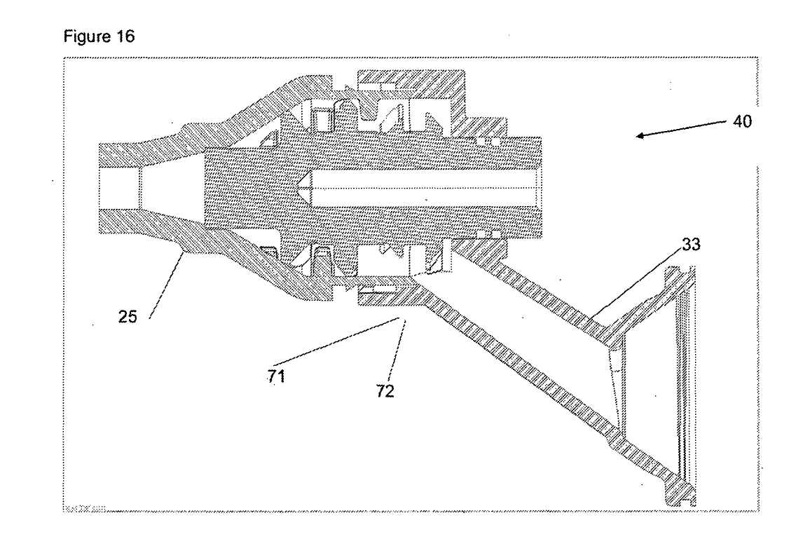

FIG. 16 shows an assembled mixer system 40 with an alternative connector system to connect the endplate 33 to the shell 25. Shown is a twist lock thread 71 on the shell 25 and a twist lock thread 72 on the endplate 33 which is engaged with a twist lock thread 71 (not shown) on the shell 25 to hold the system together.

### Illustrative Embodiments of the Invention

The following examples are provided to illustrate the invention, but are not intended to limit the scope thereof. All parts and percentages are by weight unless otherwise indicated.

Mixing Examples—A two part adhesive prepared as described in WO 2012/151086 and WO 2012/151085 with the viscosity adjusted by adding additional plasticizer to the recited press flow viscosity of 25 or 30 seconds are placed in a bag in bag tube and applied using a battery operated mixer which applies about 220 psi (1517 kPa) pressure to the mixture in the tube. A mixer having a length of 65 mm is used. A number of mixers are tested. The push current, total power used, mixed material temperature, flow rate, Shore A hardness at 30 minutes and 60 minutes are measured. The beads cured after 30 minutes are examined and a mixed percentage is assigned. The results are compiled in Table 1.

TABLE 1

| | | | | | 30 min. | | 60 min. | |
|---|---|---|---|---|---|---|---|---|
| | | Mixed | | Hard- | Hard- | | Hard- | |
| | | Mat. | Flow | ness | ness | Hard- | ness | |
| | Power | Temp | Rate | @ 30 | Std. | ness @ | Std. | *Mix |
| RS | (W) | (F.) | (g/min) | min. | Dev. | 60 min. | Dev. | % |
| 1 | 167.5 | 84.3 | 424 | 21 | 2.4 | 46 | 1.4 | 95 |
| 1 | 168.4 | 80.5 | 406 | 21 | 3.1 | 48 | 1.7 | 95 |
| 2 | 189.3 | 85.0 | 398 | 24 | 2.3 | 46 | 2.2 | 85 |
| 2 | 186.6 | 84.2 | 402 | 25 | 1.6 | 44 | 1.7 | 95 |
| 3 | 174.3 | 83.3 | 402 | 24 | 2.1 | 47 | 1.6 | 97 |
| 3 | 171.3 | 87.5 | 418 | 22 | 2.4 | 46 | 3.9 | 97 |
| 4 | 162.9 | 81.7 | 392 | 23 | 4.6 | 43 | 1.8 | 80 |
| 4 | 157.9 | 83.9 | 402 | 23 | 2.6 | 44 | 1.9 | 85 |
| 5 | 193.3 | 85.6 | 396 | 25 | 2.0 | 43 | 1.9 | 90 |
| 5 | 193.1 | 88.1 | 406 | 19 | 2.8 | 40 | 2.4 | 85 |

RS is rotatable structure. Rotatable structure 1 is a rotatable structure as disclosed having 4 flights. Rotatable structure 2 has four flights of blades wherein the last two are reverse flights. Rotatable structure 3 is a clover with 3 blades in each flight and reverse flights, Rotatable structure 4 is a clover with a radius. Rotatable structure 5 has four flights with open volume. The five rotatable structures are shown in FIG. 15. The data presented shows that all designs tested produce good mix.

Parts by weight as used herein refers to 100 parts by weight of the composition specifically referred to. Any numerical values recited in the above application include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

1. An article comprising: a rotatable structure having a cylindrical base having a connector to a rotating motor disposed at one end of the cylindrical base, a thinned end which is disposed at the opposite end of the rotatable structure from the connector, wherein the rotatable structure has a central axis passing through and is adapted to rotate around the central axis, from three to six flights of blades disposed on the cylindrical base wherein each flight of blades comprises from 3 to 6 blades which lie in a planar band perpendicular to the central axis wherein the blades of each flight are separated by notches through which viscous material under pressure can flow and the blades have an inlet face substantially perpendicular to the central axis and facing the connector end of the rotatable structure, an outlet face substantially perpendicular to the central axis and facing the thinned end of the rotatable structure, wherein the inlet face and outlet face are substantially parallel to one another, a leading edge which is an edge of a blade facing the direction of rotation, a trailing edge which is an edge of the blade opposite the leading edge, wherein the blades may have a standard leading face which connects and tapers from the leading edge to the outlet face and a standard trailing face which connects and tapers from the trailing edge to the inlet face, or a reverse leading face which connects and tapers from the leading edge to the inlet face and a reverse trailing face which connects and tapers from the trailing edge to the outlet face, the notches in adjacent flights of blades are offset from one another in the direction of the central axis; disposed on the cylindrical base are a plurality of grooves that connect the notches in adjacent flights of blades wherein the plurality of grooves are adapted to facilitate flow of viscous material from one flight of blades to the adjacent flights of blades; wherein at least two of the flights of blades have the standard leading faces and the standard trailing faces and the article is located in a dynamic mixer to mix viscous material when rotated.

2. An article according to claim 1 wherein the plurality of grooves extend from a notch in the first flight of blades through notches in each flight of blades.

3. An article according to claim 2 wherein the angle between the direction of the plurality of grooves and the planar band formed by the blades of each flight is less than 90 degrees to about 15 degrees.

4. An article according to claim 1, wherein the plurality of grooves form a helical structure in the cylindrical base as they connect the notches in each flight.

5. An article according to claim 1, wherein one or two of the flights of blades are reverse flights wherein the blades have the reverse leading faces and reverse trailing faces.

6. An article according to claim 5 wherein the reverse flights of blades are disposed on the cylindrical base opposite the connector to a rotating motor.

7. An article according to claim 1, wherein the tip of the thinned end disposed away from cylindrical base has notches adapted to enhance mixing and flow of viscous material.

8. An article comprising the rotatable structure of claim 1, wherein a shell which has an inlet end and an outlet end wherein the outlet end is smaller than the inlet end, wherein the rotatable structure is disposed in the shell, and an endplate disposed at the inlet end of the shell wherein the endplate comprises a structure to facilitate connection of the connector of the rotatable structure with a rotating motor of a dispensing apparatus, one or more inlets for viscous material to be mixed and seals the inlet end of the shell.

9. An article according to claim 8 wherein the shell has a plurality of flights of blades disposed on the inner wall of the shell wherein the blades of each flight are separated by notches.

10. An article according to claim 9 wherein the shell has 3 to 8 flights of blades and the flights of blades are disposed with respect to the flights of the blades of the cylindrical structure in a manner such that a portion of the blades of the cylindrical structure pass between the flights of blades of the shell.

11. A method comprising
a) introducing two or more parts of curable material having a high viscosity into the one or more inlets of the article according to claim 8, which is affixed to a dispensing apparatus having one or more motors for rotating the conical structure and for pushing the curable material through the article;
b) applying sufficient pressure on the curable material to move the curable material through the shell in contact with the rotatable structure, wherein the plurality of grooves on the cylindrical base of the rotatable is adapted to facilitate flow of the curable material, under conditions that the two or more parts are mixed sufficiently to cure and perform the desired function of the curable material; and
c) applying the mixed two parts of the curable material to one or more substrates.

12. A method according to claim 11 which further comprises
d) contacting a first substrate with a second substrate with the mixed curable material disposed between the two substrates; and
e) allowing the mixed curable material to cure and bond the two substrates together.

13. A method according to claim 11 wherein the viscosity of the two part of the curable material is up to about 2,500,000 centipoise.

14. A method according to claim 11, wherein the rotating motor is run at from about 150 to about 400 rpm.

15. A method according to claim 11, wherein the flow rate of the curable material through the shell is about 400 g/min or greater.

16. A method according to claim 11, wherein the two parts of the curable materials are introduced from a single tube having the lowest volume part enclosed in a bag within the highest volume part.

17. A system comprising:
the article according to claim 8, and
one or more containers containing in separate parts a curable material; and
a dispensing apparatus having one or more motors for rotating the rotatable structure and moving curable material through the article.

18. An article according to claim 3, wherein
the plurality of grooves form a helical structure in the cylindrical base as they connect the notches in each flight;
the blades have the reverse leading faces and reverse trailing faces; and
the reverse flights of blades are disposed on the cylindrical base opposite the connector to a rotating motor;

19. An article according to claim 18, wherein the tip of the thinned end disposed away from cylindrical base has notches adapted to enhance mixing and flow of viscous material.

20. An article comprising the rotatable structure of claim 3, wherein a shell which has an inlet end and an outlet end wherein the outlet end is smaller than the inlet end, wherein the rotatable structure is disposed in the shell, and an endplate disposed at the inlet end of the shell wherein the endplate comprises a structure to facilitate connection of the connector of the rotatable structure with a rotating motor of a dispensing apparatus, one or more inlets for viscous material to be mixed and seals the inlet end of the shell;
wherein the shell has a plurality of flights of blades disposed on the inner wall of the shell wherein the blades of each flight are separated by notches; and
wherein the shell has 3 to 8 flights of blades and the flights of blades are disposed with respect to the flights of the blades of the cylindrical structure in a manner such that a portion of the blades of the cylindrical structure pass between the flights of blades of the shell.
